(19) United States
(12) Patent Application Publication
(10) Pub. No.: US 2012/0059928 A1
(43) Pub. Date: Mar. 8, 2012

(54) Mobile Communication Terminal and Network System Including the Same

(75) Inventors: Dong-Man Lee, Daejeon (KR); Yang-Woo Ko, Daejeon (KR)

(73) Assignee: Korea Advanced Institute of Science and Technology (KAIST), Daejeon (KR)

(21) Appl. No.: 12/874,466

(22) Filed: Sep. 2, 2010

(51) Int. Cl. G06F 15/173

(52) U.S. Cl. 709/224; 709/223

(57) ABSTRACT

A mobile communication terminal includes a network knowledge manager collecting information required to seize an opportunity to execute an application by forming a network with a plurality of mobile communication terminals, and when a condition for executing a specific application is satisfied through the collected information, informing that the condition is satisfied, and a network instance manager generating a network instance which is a component of a network supporting the specific application, and performs management of the generated network instance including maintenance of the network instance when the specific application is executed by the network knowledge manager. A network can be promptly and ephemerally formed for a plurality of mobile communication terminals including smart phones to execute one application simultaneously, thereby reducing network management traffic required to form and maintain the network.

### BACKGROUND

1. Field of the Invention

The present invention relates to network architecture of a mobile communication terminal, and more particularly, to network architecture supporting an environment in which applications of mobile communication terminals of users are executed.

2. Description of Related Art

With the fast development of mobile communication technology and propagation of mobile phones, most people are now using multi-functional mobile phones. Multi-functional mobile phones have been evolved with multi-media functions such as a function of digital cameras or MP3 players, as well as a function of voice communication, which is an original function of the mobile phones. Further, the multi-functional mobile phones provide a mobile shopping service.

Meanwhile, recently, smart phones have taken the spotlight as intelligent terminals having computer-like functions, such as Internet communication and information search, in addition to mobile phone functions.

A smart phone is equipped with a large capacity of memory and a high-performance central processing unit (CPU) in comparison with a conventional mobile communication terminal, and also with an operating system for supporting, for example, execution of various applications, voice/data communications, and interworking with personal computers. In particular, a user may install desired downloaded applications in the smart phone. The smart phone allows for handy use of the Internet, unlike the conventional mobile communication terminal.

The technology of setting a constraint for each message and using the constraint in a routing step is disclosed in U.S. Pat. No. 7,577,107, titled “Protocol Specification for Message-initiated Constraint-based Routing” (prior art 1).

Further, heterogeneous networks formed as discrete compartments and connected to each other so that each network maintains its property is disclosed in “Basic Abstractions for an Autonomic Network Architecture” (C. Jelger, C. Tschudin, S. Schmid, and G Leduc, World of Wireless, Mobile and Multimedia Networks, 2007. WoWMoM 2007. IEEE International Symposium on a, pp. 1-6, 2007.) (prior art 2). In prior art 2, technology of providing a function of constructing a protocol stack according to a request from an individual application and forming a network according to a request from an application is disclosed.

Meanwhile, in the field of recent mobile network technology, applications can be executed on mobile communication terminals connected with each other. However, determining which applications are to be executed for which user is an important thing, and technology for automatically finding an opportunity for application execution is required because the mobile communication terminals of many users include various applications.

Accordingly, when the application execution opportunity is found and the application is executed, a network for supporting the application for the time while the application is executed is necessary. That is, technology for a network that is ad hoc, ephemeral and built to support a specific application is necessary. However, the prior art 1 cannot implement technology of tracing a change of a network formed for each application session and allowing the change to be used in an application, by considering only the delivery of an individual message. Although prior art 2 may form a network according to a request of the application, the network is a network maintained for a relatively longer time under the negotiation of individual networks rather than a network formed promptly according to needs. Therefore, prior art 2 is not appropriate for implementing an ephemeral ad-hoc network.

### SUMMARY

The present invention provides a mobile communication terminal and a network system including the mobile communication system capable of spontaneously generating a network in which an application is executed with a plurality of mobile communication terminals.

The technical objectives of the present invention are not limited to the above disclosure; other objectives may become apparent to those of ordinary skill in the art based on the following descriptions.

In accordance with an aspect of the present invention, a mobile communication terminal includes a network knowledge manager collecting information required to seize an opportunity to execute an application by forming a network with a plurality of mobile communication terminals, and when a condition for executing a specific application is satisfied by the collected information, informing that the condition is satisfied, and a network instance manager generating a network instance which is a component of a network supporting the specific application, and perform management of the generated network instance, including maintenance of the network instance, when the specific application is executed by the network knowledge manager.

In some embodiments, the mobile communication terminal may further include a network interface for forming a network by communicating with the plurality of mobile communication terminals.

In some embodiments, the network interface may include a wireless local area communication unit for wireless local area communication.

In some embodiments, the network knowledge manager may collect information including types of application programs included in the plurality of mobile communication terminals, a condition required to invoke the application, an application invocation condition set by a user of each of the mobile communication terminals, presence or absence of a service element constituting the application, topology between current mobile communication terminals, and information of a connecting method between the mobile communication terminals.

In some embodiments, the network instance manager may receive information of a network node to be included in the network, and information necessary for retrieving and maintaining the network node from the application.

In some embodiments, the network knowledge manager may detect an opportunity to execute the application by referring to a user application profile that includes information of a condition for executing the specific application.

In some embodiments, the user application profile may be distributed to other mobile communication terminals.

In accordance with another aspect of the present invention, a network system includes a network instance creator executing an application according to a selection of a user when a condition for executing the application is satisfied by forming a network with a plurality of network nodes, and a network instance member participating in the application that is executed in the network instance creator.

In some embodiments, the network system may further comprise a network instance router configured to connect the network instance creator to a network instance member.

In some embodiments, the network instance router may not participate in the application.

In some embodiments, the network instance creator, the network instance member, and the network instance router may be mobile communication terminals.

In accordance with the present invention, a network can be promptly and ephemerally formed for a plurality of mobile communication terminals including smart phones to execute one application simultaneously, thereby reducing network management traffic required to form and maintain the network.

In accordance with the present invention, an appropriate application can be recommended and executed according to a preference of a user of the mobile communication terminal, thereby contributing to a user's convenience.

In accordance with the present invention, a network required for a plurality of mobile communication terminals to execute an application can be formed and maintained in an ad hoc and ephemeral manner. Thus, it is possible to support more effective network architecture.

### BRIEF DESCRIPTION OF THE DRAWINGS

The foregoing and other features and advantages of the present inventions will be apparent from the more particular description of a preferred embodiment of the present inventions, as illustrated in the accompanying drawings in which like reference characters refer to the same parts throughout the different views. The drawings are not necessarily to scale, emphasis instead being placed upon illustrating the principles of the present inventions. In the drawings:

FIG. 1 is a block diagram illustrating an internal structure of a mobile communication terminal in accordance with an embodiment of the present invention;

FIG. 2 is a block diagram illustrating a configuration of a network system in accordance with an embodiment of the present invention;

FIGS. 3A and 3B is a flowchart illustrating an operation of a network knowledge manager in accordance with an embodiment of the present invention;

FIGS. 4A and 4B is a flowchart illustrating an operation of a network instance manager in accordance with an embodiment of the present invention.

### DETAILED DESCRIPTION OF THE EMBODIMENTS

Various embodiments will now be described more fully with reference to the accompanying drawings in which some embodiments are shown. These present inventions may, however, be embodied in different forms and should not be construed as limited to the embodiments set forth herein. Rather, these embodiments are provided so that this disclosure is thorough and complete and fully conveys the present invention to those skilled in the art. In the drawings, the sizes and relative sizes of layers and regions may be exaggerated for clarity.

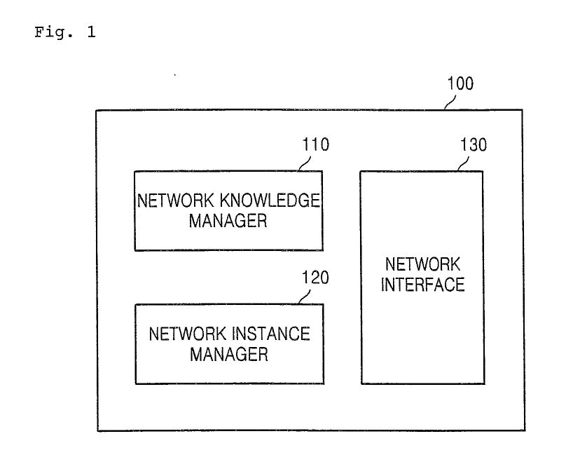

FIG. 1 is a block diagram illustrating an internal structure of a mobile communication terminal in accordance with an embodiment of the present invention.

Referring to FIG. 1, a mobile communication terminal 100 of the present invention includes a network knowledge manager 110, a network instance manager 120 and a network interface 130.

The network knowledge manager 110 collects information required to seize an opportunity to execute an application by forming a network with a plurality of mobile communication terminals, and when a condition for executing a specific application is satisfied through the collected information, informs a user of the mobile communication terminal that the condition is satisfied.

When the specific application is executed by the network knowledge manager 110, the network instance manager 120 generates a network instance which is a component of the network supporting the specific application, and performs management of the generated network instance, including maintenance of the network instance.

The network interface 130 forms a network by communicating with the plurality of mobile communication terminals. In the embodiment of the present invention, the network interface 130 may include a wireless local area communication unit for wireless local area communication with the plurality of mobile communication terminals. The wireless local area communication unit may support WiFi or Bluetooth.

In the embodiment of the present invention, the network knowledge manager 110 may collect information including types of application programs included in the plurality of mobile communication terminals, a condition required to invoke the application, an application invocation condition set by the user of each mobile communication terminal, presence or absence of a service element constituting the application, topology between current mobile communication terminals, and information for a method of connecting between the mobile communication terminals.

In the present invention, the network knowledge manager 110 may detect an opportunity to execute the application by referring to a user application profile that includes information of a condition for executing the specific application. In this case, the user application profile may be distributed to other mobile communication terminals. By doing this, the opportunity to execute the application in the mobile communication terminal 100 may be seized instead by the other mobile communication terminal.

In an embodiment of the present invention, information of a network node to be included in the network, and information necessary for retrieving and maintaining the network node may be delivered from the application to the network instance manager 120.

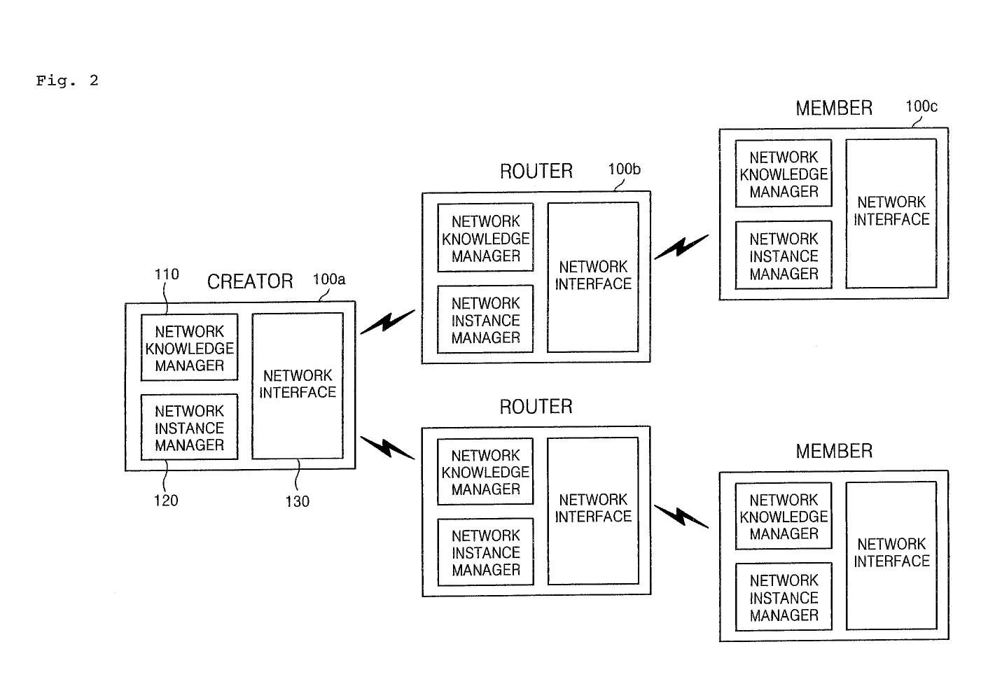

FIG. 2 is a block diagram illustrating a configuration of a network system in accordance with an embodiment of the present invention.

Referring to FIG. 2, the network system includes a network instance creator 100a, a network instance router 100b and a network instance member 100c. In an embodiment of the present invention, the network instance creator 100a, the network instance router 100b, and the network instance member 100c may be mobile communication terminals.

The network instance creator 100a executes an application according to a selection of a user when a condition for executing the application is satisfied by forming a network with a network node.

The network instance router 100b connects the network instance creator 100a to a network instance member 100c, and does not participate in an application session.

The network instance member 100c participates in the application executed by the network instance creator 100a.

The final goal of the network knowledge manager 110 is to inform the user of the mobile communication terminal 100 of an opportunity to execute an application, which is executed according to a selection of the user. The application based on network architecture proposed in an embodiment of the present invention, when executed, requests the network instance manager 120 to form a network required for the application execution. The network formed in each session of the individual application may be called a network instance to differentiate it from a general network.

In an embodiment of the present invention, a network instance includes a plurality of mobile communication terminals, which are divided into the network instance creator 100a, the network instance router 100b and the network instance member 100c.

A detailed operation of components of the mobile communication terminal and the network system having the structure as described above will now be described.

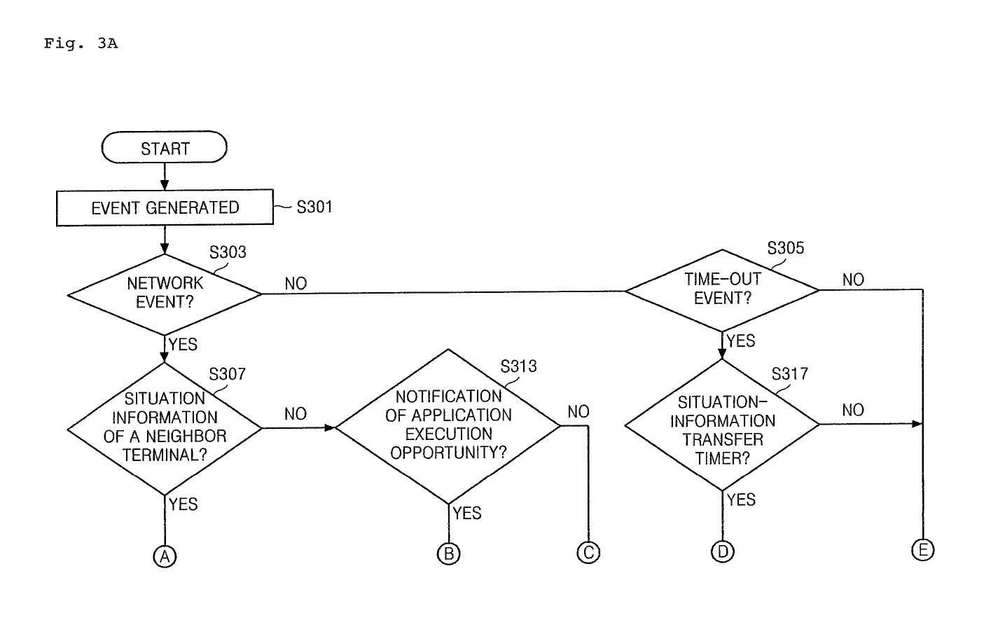

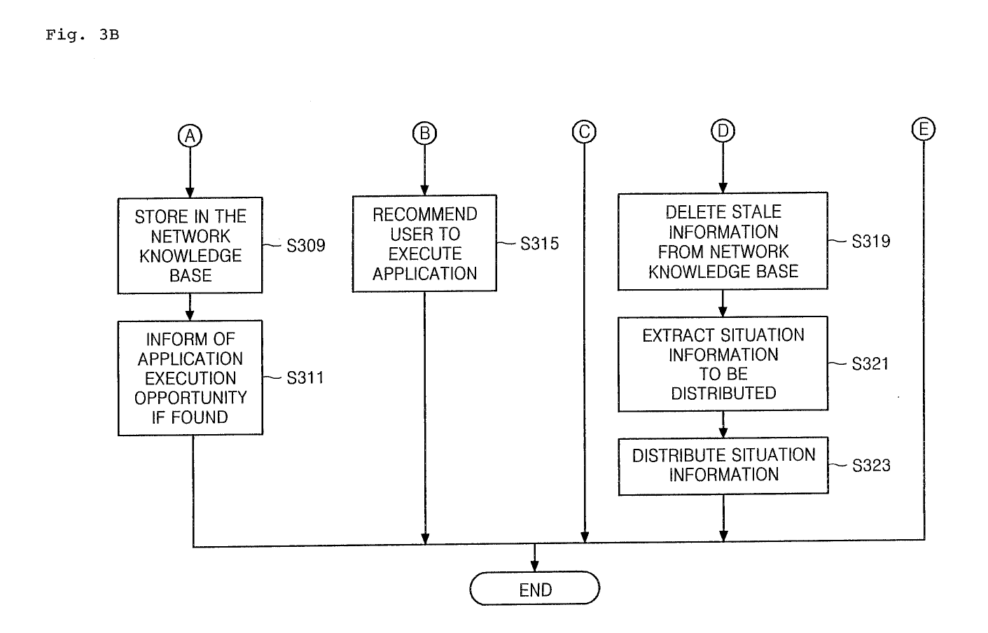

FIGS. 3A and 3B is a flowchart illustrating an operation of the network knowledge manager 110 in accordance with an embodiment of the present invention.

Referring to FIGS. 3A and 3B, when an event is generated (S301), the network knowledge manager checks whether the event is a network event (S303). The network knowledge manager 110 in the embodiment of the present invention may include a situation information delivery timer to distribute situation information periodically.

If it is checked in step S303 that the event is not a network event, the network knowledge manager checks whether the event is a time-out event (S305).

If the event is a time-out event, it is checked whether the time-out event is for a situation information delivery timer (S317). If the time-out event is for a situation information delivery timer, old information is deleted from a network knowledge base (S319). Information to be distributed to the network knowledge base is then extracted (S321). The extracted situation information is then distributed to another mobile communication terminal (S323).

In an embodiment of the present invention, all information stored in the network knowledge base may include time information at which the stored information is first generated in order to perform step S319.

In an embodiment of the present invention, various policies may be used to determine what information is to be distributed. As a simple example, all information may be distributed by preferentially distributing information which has not been distributed recently. Further, a policy to preferentially propagate new information by distributing recently received information may be implemented.

In an embodiment of the present invention, the mobile communication terminal to which the situation information is to be delivered may be determined according to a property of the network in step S323. For example, in the case of a mobile ad-hoc network, the situation information may be transmitted using a broadcasting function of the medium access control (MAC) layer.

If it is checked in S303 that the generated event is a network event, the network knowledge manager checks whether received information is situation information of a neighboring mobile communication terminal (S307).

If the network event is situation information of a neighboring mobile communication terminal, the network knowledge manager stores information received from the neighboring mobile communication terminal and updates its own network knowledge base (S309). Then, the network knowledge manager compares the updated network knowledge base with a user application profile, and when a new application opportunity is found, informs the user of the fact (S311).

In an embodiment of the present invention, the network knowledge manager uses the user application profile to find an application opportunity for the user to execute in S311. The user application profile represents a condition that should be satisfied by a current situation when the user is to execute a certain application. Here, the condition may include referencing the network knowledge base. For example, it is assumed that an execution condition in the user application profile is defined as “if a user who has a hobby in common with me appears,” and that each mobile communication terminal periodically distributes stored hobby as situation information. In this case, if a mobile communication terminal distributing a common hobby as situation information appears on the periphery of one mobile communication terminal, the network knowledge manager updates the network knowledge base using the information, and compares the condition of the user application profile with the network knowledge base to recognize that a condition to start a corresponding application is satisfied.

In an embodiment of the present invention, the user application profile may be distributed as a part of situation information, which enables an application execution opportunity of a mobile communication terminal to be retrieved by another mobile communication terminal. When the application execution opportunity found by a mobile communication terminal corresponds to another mobile communication terminal, the other mobile communication terminal is notified of that fact. This is called notification of the application execution opportunity.

If it is checked in S307 that the received information is not situation information of a neighboring mobile communication terminal, the network knowledge manager checks whether the received information is notification of the application execution opportunity (S313). If the information is notification of the application execution opportunity, the user is recommended to execute the application (S315).

In an embodiment of the present invention, the network instance manager 120 manages all procedures such as generation and maintenance of a network instance. That is, first, the network instance creator 100a distributes a network formation condition to a mobile communication terminal which is to be included in the network instance. Second, the mobile communication terminal having received the network formation condition may transmit a participation message when the mobile communication terminal is the network instance member 100c, so that the network instance is generated and maintained. Third, the network instance creator 100a, the network instance member 100c or the network instance router 100b having received the participation message may generate a network instance or maintain a connection state by recording the state. Fourth, data transmitted in an application is transmitted using a connection made in the previous step.

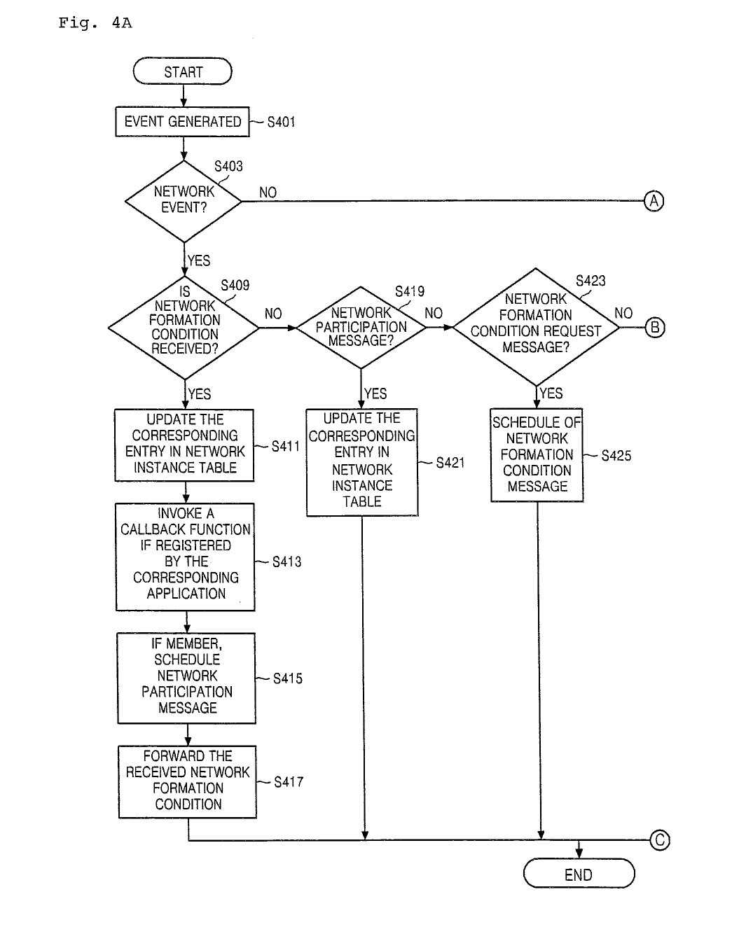

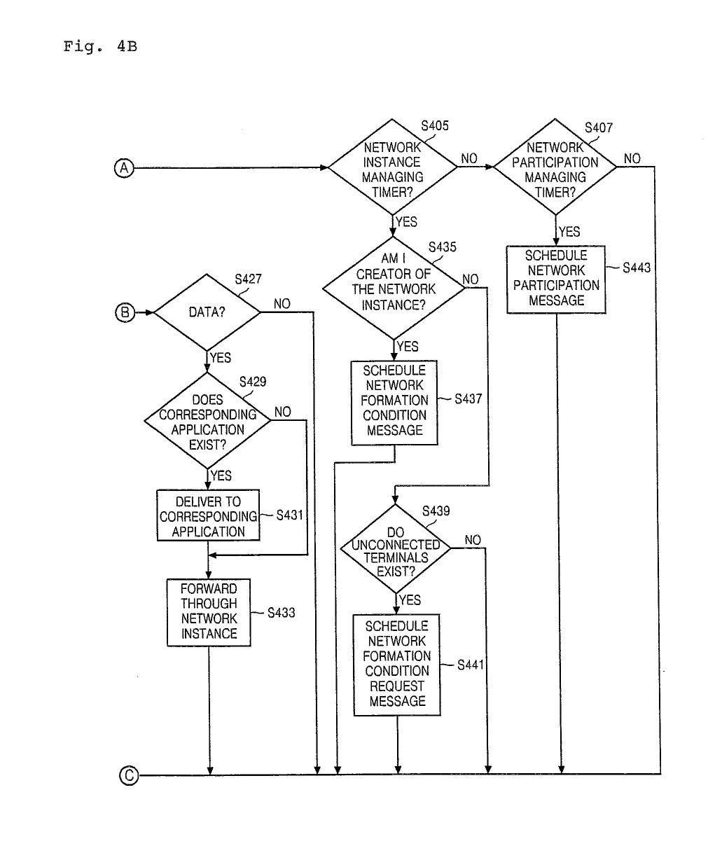

FIGS. 4A and 4B is a flowchart illustrating an operation of the network instance manager 120 in accordance with an embodiment of the present invention.

Referring to FIGS. 4A and 4B, when an event is generated in a mobile communication terminal 100 (S401), the network knowledge manager checks whether the event is a network event (S403).

In an embodiment of the present invention, two methods of maintaining a connection state of each network instance are possible. The first method is maintaining the connection state by beginning to send a message in the network instance creator 100a. The second method is maintaining the connection state by beginning to send a message in the network instance member 100c. For the first method, the network instance creator 100a may include a network instance managing timer. Each time the network instance managing timer is timed out, the network instance creator 100a distribute a message including a network formation condition (S405, S435, and S437).

When the mobile communication terminal receives a network formation condition message in S403 (S409), the network instance manager 120 finds information corresponding to the received network formation condition from a network instance table and updates the network instance table (S411). If there is no information, the network instance manager 120 adds information.

If a callback function of an application corresponding to a network instance to be updated is registered already, the callback function is called (S413). If the mobile communication terminal is the network instance member 100c of a corresponding network instance, the network instance manager 120 sends a network participation message to another mobile communication terminal (S415). The network instance manager 120 delivers the network formation condition message to the other mobile communication terminal (S417).

As described in S411, each mobile communication terminal may have the network instance table, and each entry of the table may have information of a network instance to which the mobile communication terminal belongs. One entry is generated by receiving a network formation condition for the first time, and the entry may be deleted using various methods according to a policy. For example, in an environment in which an effective deletion of the entry is difficult, a soft-state scheme that automatically deletes an entry which is not updated for a certain time may be used.

The calling of the callback function of the application in S413 allows the application to adapt to a change of network information.

As described in S415, each mobile communication terminal may determine whether the mobile communication terminal is a network instance member 100c or not from the network formation condition. That is, the network formation condition may include an explanation describing which mobile communication terminal is the network instance member 100c or which mobile communication terminal should be the network instance router 100b.

The network formation condition includes an explanation about how to propagate the condition in order to execute step S417. For example, there may be an explanation about whether the condition is to be propagated to all mobile communication terminals belonging to a certain area or to only mobile communication terminals included in a given list.

The second method for maintaining the connection state by beginning to send a message in the network instance member 100c is as follows.

In an embodiment of the present invention, the network instance member 100c includes a network participation message timer. When the timer is timed out, the network instance member 100c sends a network participation message and maintains the connection state of the network instance if the network participation message has not been sent recently (S407, S443).

The network participation message transmitted in step S415 or S443 is delivered to the network instance creator 100a, and in this process, the network instance table is updated to maintain the network instance (S421).

In an embodiment of the present invention, when the application session cannot be continued due to a big change of the connection state between terminals or any problem associated with the network instance creator 100a, the network instance member 100c may request the network instance creator 100a to send the network formation condition message when the network instance member 100c does not receive the network formation condition message for more than a certain time, in order to solve such a problem. Further, when the network formation condition message is not be received from a certain terminal for more than a certain time, the network instance member 100c or the network instance router 100b may deliver that fact to the network instance creator 100a in the form of a network formation condition request message (S439, S441).

The network instance creator 100a receiving this request immediately schedules the distribution of the network formation condition message (S423 and S425). If the network formation condition message is not received despite that the network formation condition message is requested, the application can be no longer continued and the network instance manager 120 informs the application of this fact for an appropriate action.

Data communicated by the application based on the present invention is delivered through the network instance.

That is, when the mobile communication terminal receives data (S427), the network instance manager 120 checks whether the corresponding application exists (S429).

If the corresponding application exists, the network instance manager 120 transmits the data to the application when the mobile communication terminal is the network instance member 100c (S431).

If the corresponding application does not exist, the network instance manager 120 transmits the data to another mobile communication terminal through the network instance (S433).

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this present invention as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A mobile communication terminal, comprising:
a network knowledge manager configured to collect information required to seize an opportunity to execute an application by forming a network with a plurality of mobile communication terminals, and when a condition for executing a specific application is satisfied through the collected information, inform that the condition is satisfied; and
a network instance manager configured to generate a network instance which is a component of a network supporting the specific application, and perform management of the generated network instance, including maintenance of the network instance, when the specific application is executed by the network knowledge manager.

2. The mobile communication terminal of claim 1, further comprising a network interface for forming a network by communicating with the plurality of mobile communication terminals.

3. The mobile communication terminal of claim 2, wherein the network interface includes a wireless local area communication unit for wireless local area communication.

4. The mobile communication terminal of claim 1, wherein the network knowledge manager collects information including types of application programs included in the plurality of mobile communication terminals, a condition required to invoke the application, an application invocation condition set by a user of each of mobile communication terminals, presence or absence of a service element constituting the application, topology between current mobile communication terminals, and information for a connecting method between the mobile communication terminals.

5. The mobile communication terminal of claim 1, wherein the network instance manager receives information of a network node to be included in the network, and information necessary for retrieving and maintaining the network node from the application.

6. The mobile communication terminal of claim 1, wherein the network knowledge manager detects an opportunity to execute the application by referring to a user application profile that includes information of a condition for executing the specific application.

7. The mobile communication terminal of claim 6, wherein the user application profile is capable of being distributed to other mobile communication terminals.

8. A network system, comprising:
a network instance creator configured to execute an application according to a selection of a user when a condition for executing the application is satisfied by forming a network with a plurality of network nodes; and
a network instance member configured to participate in the application that is executed by the network instance creator.

9. The network system of claim 8, further comprising a network instance router configured to connect the network instance creator to the network instance member.

10. The network system of claim 9, wherein the network instance router does not participate in the application.

11. The network system of claim 8, wherein the network instance creator is a mobile communication terminal.

12. The network system of claim 8, wherein the network instance member is a mobile communication terminal.

13. The network system of claim 9, wherein the network instance router is a mobile communication terminal.
